(19) United States
(12) Patent Application Publication
(10) Pub. No.: US 2024/0010903 A1
(43) Pub. Date: Jan. 11, 2024

(54) DEEP EUTECTIC SOLVENTS

(71) Applicant: Uniquem Inc., Calgary (CA)

(72) Inventors: Amir A. Mirzaei, Toronto (CA); Hirbod Rad, Calgary (CA)

(21) Appl. No.: 18/036,477

(22) PCT Filed: Nov. 12, 2020
(86) PCT No.: PCT/CA2020/051533

§ 371 Date: May 11, 2023

(51) Int. Cl. C09K 8/22; C09K 8/54; E21B 21/00

(52) U.S. Cl. CPC C09K 8/22; C09K 8/54; E21B 21/003; C09K 2208/12; C09K 2208/32; C09K 2208/34; E21B 41/02

(57) ABSTRACT

Described herein are deep eutectic solvents and their use as drilling fluids. The DBS typically comprises an organic salt and a metal salt; an organic salt and a hydrated metal salt; an organic salt and a hydrogen bond donor; and/or a metal salt and a hydrogen bond donor. Uses for the DESs and methods of use as drilling fluids are also described.

### FIELD

The present invention relates to deep eutectic solvents. More specifically, the present invention is, in aspects, concerned with uses of deep eutectic solvents and related compositions and methods.

### BACKGROUND

In geotechnical engineering, drilling fluid, also called drilling mud, is used to aid drilling operations. Often used while drilling oil and natural gas wells and on exploration drilling rigs, drilling fluids are also used for much simpler boreholes, such as water wells. One of the functions of drilling mud is to carry cuttings out of the hole.

When drilling or completing wells in earth formations, various fluids typically are used in the well for a variety of reasons. Common uses for well fluids include: lubrication and cooling of drill bit cutting surfaces while drilling, transportation of “cuttings” (pieces of formation dislodged by the cutting action of the teeth on a drill bit) to the surface, controlling formation fluid pressure to prevent blowouts, maintaining well stability, suspending solids in the well, minimizing fluid loss into and stabilizing the formation through which the well is being drilled, fracturing the formation in the vicinity of the well, displacing the fluid within the well with another fluid, cleaning the well, testing the well, transmitting hydraulic horsepower to the drill bit, fluid used for emplacing a packer, abandoning the well or preparing the well for abandonment, and otherwise treating the well or the formation.

While there are many variations of drilling fluids, the three main categories of drilling fluids are: water-based muds (WB); non-aqueous muds, usually called oil-based muds (OB) or more practically invert emulsion muds; and gaseous drilling fluids, in which a wide range of gases can be used.

In most drilling operations, the drilling fluid takes the form of solids suspended in liquid slurry, hence the name “mud” became a practical term in the industry. The solids were used to impart some rheological properties to the drilling fluid and for the main part to increase the density of the fluid in order to provide a suitable hydrostatic pressure through the well. The solids are usually polymers, clays and heavy weight solids.

In 2002 Abbott et al introduced Deep Eutectic Solvents (DES). DES are systems formed from a eutectic mixture of Lewis or Brønsted acids and bases which can contain a variety of anionic and/or cationic species. DESs incorporate one or more compounds in a mixture form, to give a eutectic with a melting point much lower than either of the individual components. DESs are mostly composed of quaternary ammonium compounds as hydrogen bond acceptors (HBA) and the compounds referred to as hydrogen bond donors (HBD). Many DESs are formed from choline chloride, which is a vitamin needed and produced in large quantities as a food additive for farm animals, together with a hydrogen bond donor such as organic acids and amides.

Various drilling fluids have been described in, for example, U.S. Pat. Nos. 2,109,858, 2,209,591, 2,369,407, 2,718,497, 4,301,016, 4,740,319, and 7,833,946. Despite this, there is a need for novel drilling fluids and additives for drilling fluids.

### SUMMARY

In accordance with an aspect, there is provided a drilling fluid comprising a deep eutectic solvent (DES).

In an aspect, the DES comprises an organic salt and a metal salt; an organic salt and a hydrated metal salt; an organic salt and a hydrogen bond donor; and/or a metal salt and a hydrogen bond donor.

In an aspect, the organic salt is choline chloride, bromide, acetate, formate, nitrate, bicarbonate, betain, betain hydrochloride, and/or derivatives thereof.

In an aspect, the betaine present in the DES includes trimethylglycine.

In an aspect, the metal salt is a salt of Li, Na, K, Cs, Mg, Zn, Sn, Fe, Al, Ga, and/or In.

In an aspect, the hydrated metal salt is a salt of Ca, Cr, Co, Cu, Ni, and/or Fe.

In an aspect, the hydrogen bond donor is an amide, an amino acid, a carboxylic acid, an aromatic acid, an azole, a sugar, a sugar alcohol, a diol, a triol and/or a polyol.

In an aspect, the metal salt is a salt of Al or Zn or K or Na and the hydrogen bond donor comprises an amide or a diol or a triol or a sugar alcohol or a polyol or other alcohols.

In an aspect, the sugar or sugar alcohol present in the DES includes sucrose, glucose, fructose, lactose, maltose, cellobiose, arabinose, ribose, ribulose, galactose, rhamnose, raffinose, xylose, mannose, trehalose, mannitol, sorbitol, inositol, xylitol, ribitol, galactitol, erythritol, or adonitol, or a combination thereof.

In an aspect, the hydrogen bond donor comprises Ethylene Glycol (EG), Diethylene Glycol (DEG), Triethylene Glycol (TEG), Polyethylene Glycol (PEG), Propylene Glycol (PG), Polypropylene Glycol (PPG), Glycerol, Urea, Lactic acid, Ethanolamine, Potassium Carbonate, sodium carbonate, lithium carbonate, cesium carbonate, Calcium Chloride, and/or derivatives thereof.

In an aspect, the DES improves the lubricity of a drilling fluid.

In an aspect, the DES improves the rheology of a drilling fluid.

In an aspect, the DES inhibits shale hydration.

In an aspect, the DES reduces corrosion.

In an aspect, the DES is for addition to a drilling fluid at a drilling site.

In an aspect, the DES is safe and easy to use.

In an aspect, the drilling fluid is a water-based drilling fluid.

In an aspect, the drilling fluid is a brine-based drilling fluid.

In an aspect, the drilling fluid comprises water, soluble metal salts, weight agents such as barite and/or hematite, rheology modifiers, such as bentonite and/or xanthan gum, fluid loss and lost circulation materials, such as walnut shell powder, starch, and/or polyanionic cellulose, corrosion inhibitors, oxygen scavengers, biocides, flocculants, surfactants, shale and clay inhibitors, lubricants, or combinations thereof.

In an aspect, the drilling fluid has a pH of at least about 7.

In an aspect, the drilling fluid further comprises a basic material.

In an aspect, the drilling fluid further comprises finely divided or colloidal filter cake forming solids.

In an aspect, the drilling fluid comprises the DES in an amount of from about 5% to about 95% w/w or v/v, such as from about 5%, about 10%, about 15%, about 20%, about 25%, about 30%, about 35%, about 40%, about 45%, about 50%, about 60%, about 65%, about 70%, about 75%, about 80%, about 85%, or about 90% to about 10%, about 15%, about 20%, about 25%, about 30%, about 35%, about 40%, about 45%, about 50%, about 60%, about 65%, about 70%, about 75%, about 80%, about 85%, about 90%, or about 95% w/w or w/v, such as from about 10% to about 40% w/w or w/v.

In an aspect, the drilling fluid consists of the DES.

In accordance with an aspect, there is provided a deep eutectic solvent for use in a drilling fluid.

In accordance with an aspect, there is provided a use of a deep eutectic solvent in a drilling fluid.

In accordance with an aspect, there is provided a method of drilling, the method comprising injecting the drilling fluid described herein into a borehole.

Other features and advantages of the present invention will become apparent from the following detailed description. It should be understood, however, that the detailed description and the specific examples while indicating embodiments of the invention are given by way of illustration only, since various changes and modifications within the spirit and scope of the invention will become apparent to those skilled in the art from said detailed description.

### DETAILED DESCRIPTION

### Definitions

In understanding the scope of the present application, the articles “a”, “an”, “the”, and “said” are intended to mean that there are one or more of the elements. Additionally, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives.

It will be understood that any aspects described as “comprising” certain components may also “consist of” or “consist essentially of,” (or vice versa) wherein “consisting of” has a closed-ended or restrictive meaning and “consisting essentially of” means including the components specified but excluding other components except for materials present as impurities, unavoidable materials present as a result of processes used to provide the components, and components added for a purpose other than achieving the technical effects described herein. For example, a composition defined using the phrase “consisting essentially of” encompasses any known pharmaceutically acceptable additive, excipient, diluent, carrier, and the like. Typically, a composition consisting essentially of a set of components will comprise less than 5% by weight, typically less than 3% by weight, more typically less than 1% by weight of non-specified components.

The term “additive” does not imply that a given component is present in any specific amount in the drilling fluid described herein. For example, DES as a drilling fluid additive may make up a major part of the drilling fluid, such as at least about 50%, 60%, 70%, 80%, 90%, 95% w/w or w/v or more. Alternatively, DES may make up a minor part of the drilling fluid, such as less than about 50%, 40%, 30%, 20%, 10%, 5% w/w or v/v or less. In certain aspects, the drilling fluid may consist of the TDES or consist essentially of the TDES.

The term “deep eutectic solvent” or DES has been described herein with reference to certain specific examples. It will be understood that any deep eutectic solvent is contemplated for use herein, provided the DES is useful in a drilling fluid.

It will be understood that any component defined herein as being included may be explicitly excluded by way of proviso or negative limitation, such as any specific compounds or method steps, whether implicitly or explicitly defined herein.

In addition, all ranges given herein include the end of the ranges and also any intermediate range points, whether explicitly stated or not.

Finally, terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

### Compositions and Methods

Described herein are various drilling fluids comprising, consisting of, or consisting essentially of a deep eutectic solvent (DES). Any DES may be used as described herein. DESs are largely classified depending on the nature of the complexing agent used. These are generally outlined in Table 1, with exemplary components being defined.

TABLE 1
General Formula for the Classification of DESs

| type | general formula | examples |
|---|---|---|
| type I | Organic salts + Metal salts | MS = Zn, Sn, Fe, Al, Ga, |
| | | In, Li, Na, K, Cs, Mg |
| type II | Organic salts + Hydrated | HMS = Ca, Cr, Co, Cu, Ni, Fe |
| | metal salts | |
| type III | Organic salts + HBDs | HBD = CONH₂, COOH, OH |
| type IV | Metal salts + HBDs | M = Al, Zn and HBD = CONH₂, |
| | | OH |

Binary DESs comprise a eutectic mixture of two moieties, for example:

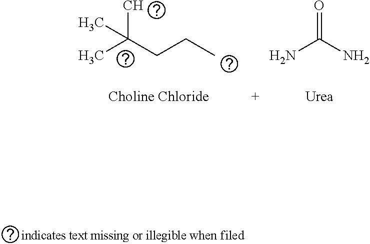

Ternary DESs comprise a mixture of three moieties, for example:

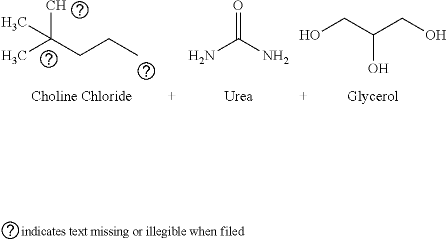

It will be understood that any and all DESs are within the scope of the present application. Certain examples are given by way of further explanation but are not limiting. In aspects, the DESs are considered environmentally friendly. In additional or alternative aspects, the DESs are considered safe. In additional or alternative aspects, the DESs are suitable for use in a drilling fluid or drilling operation. In additional or alternative aspects, the DESs are effective for increasing lubricity of a drilling fluid. In additional or alternative aspects, the DESs are effective for improving rheology of a drilling fluid. In additional or alternative aspects, the DESs are effective for inhibiting shale hydration of a drilling fluid. In additional or alternative aspects, the DESs are effective for inhibiting corrosion of a drilling fluid. In additional or alternative aspects, the DESs are biodegradable.

As described above, type I, II, and III DESs typically comprise an organic salt. Any organic salt can be used as described herein. Certain examples include choline chloride, bromide, acetate, formate, nitrate, bicarbonate, betain, betain hydrochloride, and/or derivatives thereof, such as salts, esters, etc. Any betaine may be used, an example of which is trimethylglycine.

Type I and IV DESs typically comprise metal salts and type II DESs typically comprise hydrated metal salts. The range of non-hydrated metal salts which have a suitably low melting point to form type I DESs is limited; however, the scope of deep eutectic solvents can be increased by using hydrated metal salts (type II DESs). The relatively low cost of many hydrated metal salts coupled with their inherent air/moisture insensitivity makes their use in large scale industrial processes viable.

Type III eutectics, formed from organic salts and hydrogen bond donors (HBDs), have been of interest due to their ability to solvate a wide range of compounds, including chlorides and oxides. A range of hydrogen bond donors have been studied to date, with DESs formed using amides, amino acids, carboxylic acids, aromatic acids, azoles, sugars, sugar alcohols, diols, triols, and/or polyols, for example. These liquids are simple to prepare, and relatively unreactive with water; many are biodegradable and are relatively low cost. The wide range of hydrogen bond donors available means that this class of deep eutectic solvents is particularly adaptable. The physical properties of the liquid are dependent upon the hydrogen bond donor and can be easily tailored for specific applications. This class of deep eutectic solvents have been shown to be particularly versatile, with a wide range of possible applications.

Any metal salt or hydrated metal salt may be used in the compositions described herein. Typically, the metal salt is a salt of Li, Na, K, Cs, Mg, Zn, Sn, Fe, Al, Ga, and/or In and the hydrated metal salt is a salt of Ca, Cr, Co, Cu, Ni, and/or Fe. For example, in some aspects, the metal salt is a salt of Al or Zn or K or Na and the hydrogen bond donor comprises an amide or a diol or a triol or a sugar alcohol or a polyol or other alcohols.

The sugar or sugar alcohol may be any sugar or sugar alcohol. Examples include sucrose, glucose, fructose, lactose, maltose, cellobiose, arabinose, ribose, ribulose, galactose, rhamnose, raffinose, xylose, mannose, trehalose, mannitol, sorbitol, inositol, xylitol, ribitol, galactitol, erythritol, or adonitol, or combinations thereof.

Of the four types or classes of DES mentioned above, perhaps type III has received more industrial interests than the other types combined. While other quaternary ammonium salts have been used as the organic salt part of the DES, choline chloride remains to be the most widely used organic salt. The range of hydrogen bond donors (HBDs) is wide and there are numerous options to evaluate for specific properties. Non-limiting examples of HBDs include: Ethylene Glycol (EG), Diethylene Glycol (DEG), Triethylene Glycol (TEG), Polyethylene Glycol (PEG), Propylene Glycol (PG), Polypropylene Glycol (PPG), Glycerol, Urea, Lactic acid, Ethanolamine, Potassium Carbonate, sodium carbonate, lithium carbonate, cesium carbonate, Calcium Chloride, and combinations thereof.

In aspects, the DES comprises an organic acid, an amide, a carbamide, an azole, an aromatic acid, an aliphatic acid, an alcohol, a diol, a triol, a sugar, a sugar alcohol, an amino acid, a betaine, an alkyl betaine, a quaternary ammonium salt, or a phosphonium salt, or a sulfonium salt or a combination thereof.

Any quaternary ammonium salt and phosphonium salt may be used. Typically, however, these comprise choline, N-ethyl-2-hydroxy-N,N-dimethylethanaminium, ethyl ammonium, 2-chloro-N, N, N-trimethylethanaminium, 2-fluoro-N,N,N-trimethylethanaminium, tetrabutylammonium, tetrapropylammonium, N,N-diethylethanolammonium, N,N,N-trimethyl(phenyl)methanaminium, N-benzyl-2-hydroxy-N-(2-hydroxyethyl)-N-methylethanaminium, 2-(acetyloxy)-N,N,N-trimethylethanaminium, 1-butyl-3-methylimidazolium, benzyltriphenylphosphonium, or methyltriphenylphosphonium or a combination thereof.

Likewise, any salt may be used. Typically, the salt present in the DES comprises a halide salt.

The organic acid present in the DES is not limited. Typically, however, the organic acid comprises malic acid, maleic acid, malonic acid, citric acid, lactic acid, gluconic acid, pyruvic acid, fumaric acid, succinic acid, itaconic acid, levulinic acid, glycolic acid, glutaric acid, phenylpropionic acid, phenylacetic acid, acetic acid, aconitic acid, tartaric acid, ascorbic acid, oxalic acid, glucuronic acid, neuraminic acid, phytic acid, or sialic acid, or a combination thereof.

Similarly, the amino acid present in the DES is not limiting but typically comprises y-amino butyric acid, alanine, β-alanine, glutamic acid, aspartic acid, asparagine, lysine, arginine, proline, or threonine, or a combination thereof.

The various components in the DESs can be used in different ratios. For example, in the case of a type III DES, comprising an organic salt and an HBD, the ratio of organic salt to HBD may be from about 1:10 to about 10:1, such as from about 1:10, 1:9, 1:8, 1:7, 1:6, 1:5, 1:4, 1:3, 1:2, 1:1, 2:1, 3:1, 4:1, 5:1, 6:1, 7:1, 8:1, or 9:1 to about 1:9, 1:8, 1:7, 1:6, 1:5, 1:4, 1:3, 1:2, 1:1, 2:1, 3:1, 4:1, 5:1, 6:1, 7:1, 8:1, 9:1, or 10:1. Similar ratios can be used for type I, II, and IV DESs.

In typical aspects where the DES does not make up the entirety of the drilling fluid, brine and/or water is added to the DES to form a drilling fluid. The brine and/or water may be added from about 5% to about 95% w/w or v/v, such as from about 5%, about 10%, about 15%, about 20%, about 25%, about 30%, about 35%, about 40%, about 45%, about 50%, about 60%, about 65%, about 70%, about 75%, about 80%, about 85%, or about 90% to about 10%, about 15%, about 20%, about 25%, about 30%, about 35%, about 40%, about 45%, about 50%, about 60%, about 65%, about 70%, about 75%, about 80%, about 85%, about 90%, or about 95% w/w or w/v, such as from about 60% to about 90% w/w or w/v.

Typically, the DES described herein provides beneficial properties to a drilling fluid in which it is included. For example, in aspects, the DES improves the lubricity of a drilling fluid. In additional or alternative aspects, the DES improves the rheology of a drilling fluid. In additional or alternative aspects, the DES inhibits shale hydration. In additional or alternative aspects, the DES reduces corrosion.

Typically, the DES is safe and easy to use and can be used as a drilling fluid or added to a drilling fluid at a drilling site. In this way, the DES can be used as needed and added in desired quantities depending on the drilling needs.

Any drilling fluid may be used with the DES described herein, however, typically, the drilling fluid is a water-based drilling fluid. In aspects, the drilling fluid is a brine-based drilling fluid.

Drilling fluid may contain many different excipients or additional components to assist in obtaining desirable properties. For example, the drilling fluids in aspects comprise water, soluble metal salts, weight agents such as barite and/or hematite, rheology modifiers, such as bentonite and/or xanthan gum, fluid loss and lost circulation materials, such as walnut shell powder, starch, and/or polyanionic cellulose, corrosion inhibitors, oxygen scavengers, biocides, flocculants, surfactants, shale and clay inhibitors, lubricants, or combinations of any of these components. The drilling fluid in aspects comprises a finely divided or colloidal filter cake forming solids.

The drilling fluid typically has a pH that is about 7 or higher, such as about 6, about 7, about 8, or about 9 or more. The pH is typically adjusted to a desirable level through inclusion of a basic material in the drilling fluid.

The DES can be included in the drilling fluid in any amount or ratio. Typically, it is present in an amount of from about 5% to about 95% w/w or v/v, such as from about 5%, about 10%, about 15%, about 20%, about 25%, about 30%, about 35%, about 40%, about 45%, about 50%, about 60%, about 65%, about 70%, about 75%, about 80%, about 85%, or about 90% to about 10%, about 15%, about 20%, about 25%, about 30%, about 35%, about 40%, about 45%, about 50%, about 60%, about 65%, about 70%, about 75%, about 80%, about 85%, about 90%, or about 95% w/w or w/v, such as from about 10% to about 40% w/w or w/v.

In additional aspects, a method for drilling, such as for drilling a borehole, is described herein. The method comprises drilling a borehole and injecting the drilling fluid described herein into the borehole.

The above disclosure generally describes the present invention. A more complete understanding can be obtained by reference to the following specific Examples. These Examples are described solely for purposes of illustration and are not intended to limit the scope of the invention. Changes in form and substitution of equivalents are contemplated as circumstances may suggest or render expedient. Although specific terms have been employed herein, such terms are intended in a descriptive sense and not for purposes of limitation.

### EXAMPLES

### Example 1: Preparation of DES

16 Deep Eutectic Solvents were synthesized using 1 mole of Choline chloride or potassium carbonate and selected moles of Ethylene Glycol, Glycerol and other HBDs respectively as shown in Table 2. Briefly, the constituents as listed in Table 1 were mixed and heated for between 2-4 hours at 85-95 C.

TABLE 2

| DES | | | | Brine | Brine |
|---|---|---|---|---|---|
| No. | Organic salt | HBD | Mole:Mole | added | weight % |
| 1 | Choline Chloride | Urea | 1:2 | Yes | 60 |
| 2 | Choline Chloride | Glycerol | 1:5 | Yes | 60 |
| 3 | Choline Chloride | Lactic acid | 1:1 | No | 0 |
| 4 | Choline Chloride | Lactic acid | 1:2 | Yes | 60 |
| 5 | Choline Chloride | EG | 1:4 | No | 0 |
| 6 | Choline Chloride | EG | 1:4 | Yes | 60 |
| 7 | Choline Chloride | MEA | 1:2 | Yes | 60 |
| 8 | Choline Chloride | DEG | 1:2 | Yes | 60 |
| 9 | Choline Chloride | TEG | 1:2 | Yes | 60 |
| 10 | Choline Chloride | PEG | 1:3 | Yes | 60 |
| 11 | Choline Chloride | PG | 1:4 | Yes | 60 |
| 12 | Choline Chloride | PPG | 1:4 | Yes | 60 |
| 13 | Choline Chloride | Fructose | 3:1 | Yes | 60 |
| 14 | Choline Chloride | Glucose | 3:1 | Yes | 60 |
| 15 | Potassium Carbonate | Glycerol | 1:5 | Yes | 60 |
| 16 | Choline Chloride | Calcium Chloride hexahydrate | 1:1 | Yes | 60 |

### Example 2: Evaluation of DES-Based Drilling Fluids

### Lubricity Measurements:

Lubricity is one of the most important functional properties of drilling fluids that directly affects the time spent on a drilling job. To evaluate the lubricity, it is a standard practice in the industry to use a specifically designed lubricity tester. A Fann Lubricity tester Model-212 was used to evaluate the DES-based fluids. The equipment was calibrated between the tests and 150 psi setting was used. Results are shown in Table 3.

TABLE 3

| Min. | DES-1 | DES-2 | DES-3 | DES-4 | DES-5 | DES-6 | DES-7 | DES-8 | DES-9 | DES-10 |
|---|---|---|---|---|---|---|---|---|---|---|
| 0.00 | 7.2 | 4.2 | 5.5 | 8.2 | 7.1 | 7.9 | 8.8 | 8.7 | 8.7 | 8.5 |
| 0.50 | 7.2 | 4 | 5.5 | 8.2 | 6.5 | 8.2 | 6.9 | 5.9 | 6.3 | 8.5 |
| 1.00 | 7.3 | 3.9 | 5.6 | 8.9 | 5 | 6.1 | 6 | 5.7 | 5.2 | 8.5 |
| 1.50 | 7.2 | 3.7 | 5.7 | 8.8 | 4.9 | 6.9 | 5.2 | 5.5 | 4.9 | 7.5 |
| 2.00 | 7.3 | 3.4 | 5.8 | 8.7 | 4.8 | 5.5 | 5.1 | 5 | 4.5 | 7.4 |
| 2.50 | 7.4 | 3 | 5.9 | 8.6 | 4.7 | 5.4 | 5 | 4.4 | 4.4 | 7.3 |
| 3.00 | 7.4 | 3.1 | 6 | 8.5 | 4.5 | 5.2 | 4.9 | 4.1 | 4.3 | 7.4 |
| 3.50 | 7.4 | 3.2 | 6.2 | 8.4 | 4.2 | 5 | 4.8 | 4.2 | 4.2 | 7.4 |
| 4.00 | 7.5 | 3.3 | 6.3 | 8.5 | 4 | 4.9 | 4.9 | 3.9 | 3.9 | 7.5 |
| 4.50 | 7.5 | 3.4 | 6.3 | 8.4 | 3.9 | 4.8 | 4.8 | 3.7 | 3.8 | 7.6 |
| 5.00 | 7.6 | 3.5 | 6.4 | 8.4 | 3.8 | 4.7 | 4.7 | 3.8 | 3.7 | 7.7 |

| Min. | DES-11 | DES-12 | DES-13 | DES-14 | DES-15 | DES-16 | Distillate | DES-15-Re |
|---|---|---|---|---|---|---|---|---|
| 0.00 | 7.1 | 26 | 11.1 | 16.4 | 3 | 6.5 | 5.2 | 2.5 |
| 0.50 | 6.5 | 24.1 | 10.8 | 16.5 | 3.1 | 5.6 | 5.2 | 2.6 |
| 1.00 | 6.3 | 24 | 10.7 | 16.6 | 3.2 | 5.5 | 5.2 | 2.7 |
| 1.50 | 7 | 23.7 | 10.6 | 17 | 3.2 | 5.5 | 4.9 | 2.6 |
| 2.00 | 6.7 | 23.5 | 10.3 | 17.2 | 3.2 | 5.4 | 4.8 | 2.5 |
| 2.50 | 6.5 | 23.3 | 10 | 17.3 | 3.3 | 5.3 | 4.7 | 2.6 |
| 3.00 | 6.4 | 23.1 | 10 | 17.1 | 3.4 | 5.2 | 4.8 | 2.9 |
| 3.50 | 6.3 | 23 | 9.9 | 17.4 | 3.4 | 5.3 | 4.8 | 3 |
| 4.00 | 6.3 | 22.9 | 9.9 | 17.5 | 3.3 | 5.2 | 4.9 | 2.9 |
| 4.50 | 6.2 | 22.7 | 10 | 17.4 | 3.4 | 5.3 | 4.9 | 2.8 |
| 5.00 | 6.3 | 22.6 | 9.9 | 17.5 | 3.4 | 5.2 | 4.8 | 2.7 |

### Rheology Measurements:

Rheology is another functional property of the drilling fluid. Select fluids were evaluated based on visual observation. The properties indicate that with some variations in viscosity and density, all fluids are applicable in the drilling operation. Results are shown in Table 4.

TABLE 4

| | DES-1 | DES-2 | DES-3 | DES-4 | DES-5 | DES-6 | DES-7 | DES-8 | DES-9 |
|---|---|---|---|---|---|---|---|---|---|
| 600 | 8.4 | 11.6 | — | — | 13.4 | 12.9 | — | — | — |
| 300 | 4.2 | 5.9 | — | — | 6.8 | 6.5 | — | — | — |
| 200 | 3.1 | 4.2 | — | — | 4.6 | 4.5 | — | — | — |
| 100 | 1.6 | 2.4 | — | — | 2.6 | 2.5 | — | — | — |
| 6 | 0.1 | 0.2 | — | — | 0.1 | 0.1 | — | — | — |
| 3 | 0.1 | 0.1 | — | — | 0.1 | 0.1 | — | — | — |
| PV | 4.2 | 5.7 | — | — | 6.6 | 6.4 | — | — | — |
| YP | 0 | 0.1 | — | — | 0.1 | 0.1 | — | — | — |
| Density | 1265 | 1275 | — | — | — | — | — | — | — |

| | DES-10 | DES-11 | DES-12 | DES-13 | DES-14 | DES-15 | DES-16 | DES-10-RE |
|---|---|---|---|---|---|---|---|---|
| 600 | 13.9 | 17 | — | — | — | 11.1 | 27.4 | 14 |
| 300 | 7.1 | 9 | — | — | — | 5.7 | 14.3 | 7.2 |
| 200 | 4.7 | 5.9 | — | — | — | 3.9 | 9.6 | 4.7 |
| 100 | 2.7 | 3.3 | — | — | — | 2.2 | 4.8 | 2.7 |
| 6 | 0.1 | 0.2 | — | — | — | 0.1 | 0.3 | 0.1 |
| 3 | 0.1 | 0.1 | — | — | — | 0.1 | 0.2 | 0.1 |
| PV | 6.8 | 8 | — | — | — | 5.4 | 13.1 | 6.8 |
| YP | 0.15 | 0.5 | — | — | — | 0.15 | 0.6 | 0.2 |
| Density | — | — | — | — | — | — | — | — |

### Shale Inhibition Tests:

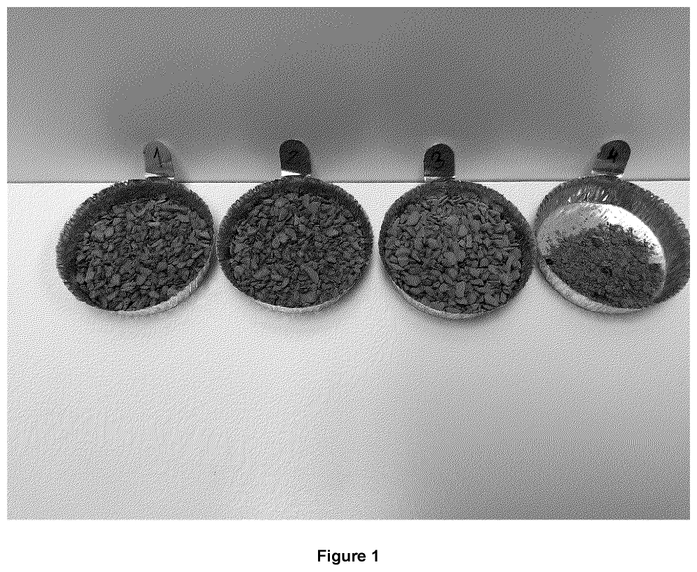

Drilling through shale formation for oil and gas recovery has been a major development in recent years. Perhaps the most important problem in drilling through shale formations is shale hydration and its inhibition. Various additives were developed and added to the water-based fluids and in many cases oil-based fluids were used to avoid potential hydration of shales. To evaluate shale hydration and its inhibition efficiency, samples of highly susceptible shales (Pierre shale) were weighed and added to the select DES based drilling fluid and tap water as a reference. The mixtures were hot-rolled for 24 hours at 60 C after which they were cooled down, screen separated, dried and weighed again. Images of the shale are in FIG. 1. The difference in weight is indicative of the hydration induced disintegration from which a recovery ratio is calculated, as shown in Table 5.

TABLE 5

| | | Mass (g) | | | | |
|---|---|---|---|---|---|---|
| | | Shale | | Shale & | Shale | Recovery |
| | Fluid | initial | Boat | boat final | final | (%) |
| 1 | DES-2 | 19.9 | 1.08 | 14.74 | 13.66 | 68.64 |
| 2 | DES-7 | 19.92 | 1.07 | 17.2 | 16.13 | 80.97 |
| 3 | DES-12 | 19.92 | 1.08 | 20.74 | 19.66 | 98.69 |
| 4 | Tap Water (TW) | 19.98 | 1.05 | 1.98 | 0.93 | 4.65 |

### Corrosion Test:

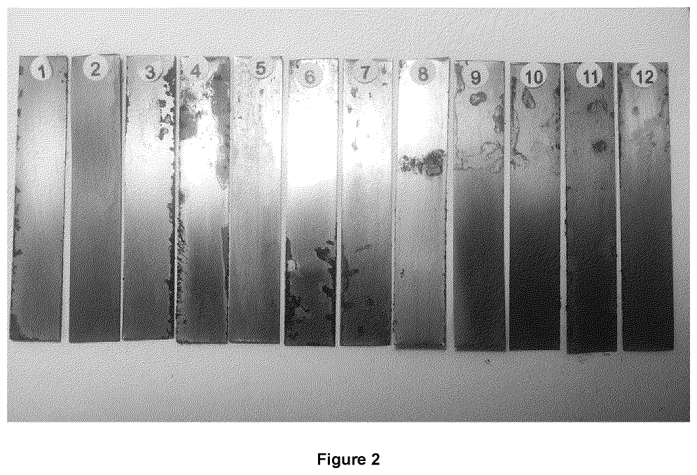

Corrosion and corrosivity is another important feature of the drilling fluids. One reason for popularity of oil-based drilling fluids is their low corrosivity. On the contrary, while brine-based drilling fluids have some technical advantages over oil-based drilling fluids, they suffer from high corrosivity. To measure the corrosivity of DES-based drilling fluids, 250 ml samples of DES-based fluids were placed in cylinders and coupons of the same or close metallurgy of the exposed drilling tools were weighed and placed inside the cylinders. The cylinders were sealed and rotated for 48 hours at 70 C after which they were cooled, and the coupons were weighed again and observed for pitting, as shown in Table 6 and FIG. 2.

TABLE 6

| | Initial | Final | Weight | Corrosion | |
|---|---|---|---|---|---|
| | weight | weight | loss | rate | |
| | (grams) | (grams) | (grams) | (MPY) | Pitting |
| DES-1 | 8.626 | 8.606 | 0.02 | 5 | Edges |
| DES-2 | 8.626 | 8.618 | 0.008 | 2 | No |
| DES-4 | 8.62 | 8.59 | 0.03 | 8 | Edges |
| Saturated Brine | 8.671 | 8.246 | 0.425 | 110 | Sever |
| DES-6 | 8.638 | 8.631 | 0.007 | 2 | Few |
| DES-7 | 8.658 | 8.629 | 0.029 | 8 | Some |
| DES-8 | 8.681 | 8.665 | 0.016 | 4 | Some |
| DES-11 | 8.616 | 8.594 | 0.022 | 6 | Edges |
| DES-12 | 8.604 | 8.598 | 0.006 | 2 | Few |
| DES-13 | 8.611 | 8.599 | 0.012 | 3 | Few |
| DES-14 | 8.662 | 8.633 | 0.029 | 8 | Some |
| DES-15 | 8.632 | 8.612 | 0.02 | 5 | Edges |

The above disclosure generally describes the present invention. Although specific terms have been employed herein, such terms are intended in a descriptive sense and not for purposes of limitation.

All publications, patents and patent applications cited above are herein incorporated by reference in their entirety to the same extent as if each individual publication, patent or patent application was specifically and individually indicated to be incorporated by reference in its entirety.

Although preferred embodiments of the invention have been described herein in detail, it will be understood by those skilled in the art that variations may be made thereto without departing from the spirit of the invention or the scope of the appended claims.

1. A drilling fluid comprising a deep eutectic solvent (DES).

2. The drilling fluid of claim 1, wherein the DES comprises an organic salt and a metal salt; an organic salt and a hydrated metal salt; an organic salt and a hydrogen bond donor; and/or a metal salt and a hydrogen bond donor.

3. The drilling fluid of claim 2, wherein the organic salt is choline chloride, bromide, acetate, formate, nitrate, bicarbonate, betain, betain hydrochloride, and/or derivatives thereof.

4. The drilling fluid of claim 3, wherein the betaine present in the DES includes trimethylglycine.

5. The drilling fluid of any one of claim 2 or 4, wherein the metal salt is a salt of Li, Na, K, Cs, Mg, Zn, Sn, Fe, Al, Ga, and/or In.

6. The drilling fluid of any one of claims 2 to 5, wherein the hydrated metal salt is a salt of Ca, Cr, Co, Cu, Ni, and/or Fe.

7. The drilling fluid of any one of claims 2 to 6, wherein the hydrogen bond donor is an amide, an amino acid, a carboxylic acid, an aromatic acid, an azole, a sugar, a sugar alcohol, a diol, a triol, and/or a polyol.

8. The drilling fluid of any one of claims 2 to 7, wherein the metal salt is a salt of Al or Zn or K or Na and the hydrogen bond donor comprises an amide or a diol or a triol or a sugar alcohol or a polyol or other alcohols.

9. The drilling fluid of claim 8, wherein the sugar or sugar alcohol present in the DES comprises sucrose, glucose, fructose, lactose, maltose, cellobiose, arabinose, ribose, ribulose, galactose, rhamnose, raffinose, xylose, mannose, trehalose, mannitol, sorbitol, inositol, xylitol, ribitol, galactitol, erythritol, or adonitol, or a combination thereof.

10. The drilling fluid of any one of claims 2 to 9, wherein the hydrogen bond donor comprises Ethylene Glycol (EG), Diethylene Glycol (DEG), Triethylene Glycol (TEG), Polyethylene Glycol (PEG), Propylene Glycol (PG), Polypropylene Glycol (PPG), Glycerol, Urea, Lactic acid, Ethanolamine, Potassium Carbonate, sodium carbonate, lithium carbonate, cesium carbonate, Calcium Chloride, and/or derivatives thereof.

11. The drilling fluid of any one of claims 1 to 10, wherein the DES comprises an organic acid, an amide, a carbamide, an azole, an aromatic acid, an aliphatic acid, an alcohol, a diol, a triol, a sugar, a sugar alcohol, an amino acid, a betaine, an alkyl betaine, a quaternary ammonium salt, or a phosphonium salt, or a sulfonium salt or a combination thereof.

12. The drilling fluid of claim 11, wherein the quaternary ammonium salt and phosphonium salt present in the DES comprise choline, N-ethyl-2-hydroxy-N,N-dimethylethanaminium, ethyl ammonium, 2-chloro-N,N,N-trimethylethanaminium, 2-fluoro-N,N,N-trimethylethanaminium, tetrabutylammonium, tetrapropylammonium, N,N-diethylethanolammonium, N,N,N-trimethyl(phenyl)methanaminium, N-benzyl-2-hydroxy-N-(2-hydroxyethyl)-N-methylethanaminium, 2-(acetyloxy)-N,N,N-trimethylethanaminium, 1-butyl-3-methylimidazolium, benzyltriphenylphosphonium, or methyltriphenylphosphonium or a combination thereof.

13. The drilling fluid of claim 11 or 12, wherein the salt present in the DES comprises a halide salt.

14. The drilling fluid of any one of claims 11 to 13, wherein the organic acid present in the DES comprises malic acid, maleic acid, malonic acid, citric acid, lactic acid, gluconic acid, pyruvic acid, fumaric acid, succinic acid, itaconic acid, levulinic acid, glycolic acid, glutaric acid, phenylpropionic acid, phenylacetic acid, acetic acid, aconitic acid, tartaric acid, ascorbic acid, oxalic acid, glucuronic acid, neuraminic acid, phytic acid, or sialic acid, or a combination thereof.

15. The drilling fluid of any one of claims 11 to 14, wherein the amino acid present in the DES comprises y-amino butyric acid, alanine, β-alanine, glutamic acid, aspartic acid, asparagine, lysine, arginine, proline, or threonine, or a combination thereof.

16. The drilling fluid of any one of claims 1 to 15, wherein the DES improves the lubricity of a drilling fluid.

17. The drilling fluid of any one of claims 1 to 16, wherein the DES improves the rheology of a drilling fluid.

18. The drilling fluid of any one of claims 1 to 17, wherein the DES inhibits shale hydration.

19. The drilling fluid of any one of claims 1 to 18, wherein the DES reduces corrosion.

20. The drilling fluid of any one of claims 1 to 19, wherein the DES is for addition to a drilling fluid at a drilling site.

21. The drilling fluid of any one of claims 1 to 20, wherein the DES is safe and easy to use.

22. The drilling fluid of any one of claims 1 to 21, wherein the drilling fluid is a water-based drilling fluid.

23. The drilling fluid of any one of claims 1 to 21, wherein the drilling fluid is a brine-based drilling fluid.

24. The drilling fluid of any one of claims 1 to 23, comprising water, soluble metal salts, weight agents such as barite and/or hematite, rheology modifiers, such as bentonite and/or xanthan gum, fluid loss and lost circulation materials, such as walnut shell powder, starch, and/or polyanionic cellulose, corrosion inhibitors, oxygen scavengers, biocides, flocculants, surfactants, shale and clay inhibitors, lubricants, or combinations thereof.

25. The drilling fluid of any one of claims 1 to 24, wherein the drilling fluid has a pH of at least about 7.

26. The drilling fluid of any one of claims 1 to 25, further comprising a basic material.

27. The drilling fluid of any one of claims 1 to 26, further comprising finely divided or colloidal filter cake forming solids.

28. The drilling fluid of any one of claims 1 to 27, comprising the DES in an amount of from about 5% to about 95% w/w or v/v, such as from about 5%, about 10%, about 15%, about 20%, about 25%, about 30%, about 35%, about 40%, about 45%, about 50%, about 60%, about 65%, about 70%, about 75%, about 80%, about 85%, or about 90% to about 10%, about 15%, about 20%, about 25%, about 30%, about 35%, about 40%, about 45%, about 50%, about 60%, about 65%, about 70%, about 75%, about 80%, about 85%, about 90%, or about 95% w/w or w/v, such as from about 10% to about 40% w/w or w/v.

29. The drilling fluid of any one of claims 1 to 28 consisting of the DES.

30. A deep eutectic solvent for use in a drilling fluid.

31. Use of a deep eutectic solvent in a drilling fluid.

32. A method of drilling, the method comprising injecting the drilling fluid of any one of claims 1 to 29 into a borehole.
